(19) United States
(12) Patent Application Publication
(10) Pub. No.: US 2013/0176950 A1
(43) Pub. Date: Jul. 11, 2013

(54) Mechanism for Controlling Transmission of Control Signal to Communication Device

(71) Applicants: Sami-Jukka HAKOLA, Kempele (FI); Samuli Turtinen, li (FI); Timo Koskela, Oulu (FI)

(72) Inventors: Sami-Jukka HAKOLA, Kempele (FI); Samuli Turtinen, li (FI); Timo Koskela, Oulu (FI)

(73) Assignee: Renesas Mobile Corporation, Tokyo (JP)

(21) Appl. No.: 13/346,869

(22) Filed: Jan. 10, 2012

(30) Foreign Application Priority Data
Jan. 9, 2012 (GB) 1200276.2

(51) Int. Cl. H04W 72/04

(52) U.S. Cl. 370/329

(57) ABSTRACT

There is provided a mechanism for controlling a transmission of a dedicated control signal or control information to a communication network element. Free resources of a PHICH which are linked to an UL transmission but not occupied by ACK/NACK information are determined and selected for transmitting a D2D specific control signal to a D2D device.

### BACKGROUND OF THE INVENTION

### Field of the invention

The present invention relates to a mechanism usable for controlling a transmission of a dedicated control signal or control information to a communication network element. In particular, the present invention is related to apparatuses, methods and computer program products providing a mechanism by means of which control signals related to a specific communication function, e.g. a D2D communication, can be provided from a communication network control element like an eNB or the like to D2D devices.

The following meanings for the abbreviations used in this specification apply:

ACK: acknowledgement

ARQ: automatic repeat request

BS: base station

D2D: device-to-device

DL: downlink

eNB: enhanced node B

EUTRAN: evolved universal terrestrial radio access network

HARQ: hybrid ARQ

LTE: Long Term Evolution

LTE-A: LTE Advanced

MAC: medium access control

NACK: non-acknowledgement

OFDM: orthogonal frequency division multiplexing

PBCH: physical broadcast channel

PDCCH: physical download control channel

PDU: protocol data unit

PHICH: physical hybrid ARQ indicator channel

PUSCH: physical uplink shared channel

RE: resource element

RRC: radio resource control

SR: scheduling request

TTI: transmission time interval

UE: user equipment

UL: uplink

UL-SCH: uplink shared channel

In the last years, an increasing extension of communication networks, e.g. of wire based communication networks, such as the Integrated Services Digital Network (ISDN), DSL, or wireless communication networks, such as the cdma2000 (code division multiple access) system, cellular 3rd generation (3G) communication networks like the Universal Mobile Telecommunications System (UMTS), enhanced communication networks based e.g. on LTE, cellular 2nd generation (2G) communication networks like the Global System for Mobile communications (GSM), the General Packet Radio System (GPRS), the Enhanced Data Rates for Global Evolutions (EDGE), or other wireless communication system, such as the Wireless Local Area Network (WLAN), Bluetooth or Worldwide Interoperability for Microwave Access (WiMAX), took place all over the world. Various organizations, such as the 3rd Generation Partnership Project (3GPP), Telecoms & Internet converged Services & Protocols for Advanced Networks (TISPAN), the International Telecommunication Union (ITU), 3rd Generation Partnership Project 2 (3GPP2), Internet Engineering Task Force (IETF), the IEEE (Institute of Electrical and Electronics Engineers), the WiMAX Forum and the like are working on standards for telecommunication network and access environments.

Recently, so-called “proximity-based” applications and services came into the focus of further developments in the field of telecommunications. The term proximity-based applications and services may be used, for example, in cases where two or more communication network devices (i.e. for example two or more users), which are close to each other, are interested in exchanging data, if possible, directly with each other.

For future cellular communication networks, a possible method for such proximity-based applications and services is the so-called device-to-device (D2D) communication functionality. D2D may offer a high communication speed, large capacity and a high quality of service which are important features to be achieved. Advantages achievable by the implementation of D2D communications in the cellular communication environment are, for example, an offloading of the cellular system, reduced battery consumption due to lower transmission power, an increased data rate, an improvement in local area coverage robustness to infrastructure failures and also an enablement of new services. This is possible while also providing access to licensed spectrum with a controlled interference environment to avoid the uncertainties of license exempt band. Due to this, D2D communication gains more and more attraction and interest.

However, in order to make a D2D discovery and communication applicable to communication networks, such as those based on 3GPP LTE or LTE-A systems, it is necessary to evolve a suitable platform in order to intercept the demand of proximity-based applications so that it is possible that devices, such as UEs or the like, can conduct discovery functions and hence establish a D2D communication with each other directly over the air, and potentially communicate directly. Hence, one important task is to provide mechanisms allowing configuration and control of e.g. radio level discovery functionality. This task is to be combined with the requirement to provide a certain level of control for the network operator side. For example, the discovery process needs also to be coupled with a system architecture and a security architecture that allow the 3GPP operators to retain control of the device behavior, for example to control who can emit discovery signals, when and where, what information these signals should carry, and what actions the corresponding devices should take once they discover each other.

### SUMMARY OF THE INVENTION

It is an object of the invention to provide an apparatus, method and computer program product by means of which control signals or control information can be provided to a communication network element, such as a D2D communication device. In particular, the present invention is related to an improved mechanism usable for allocating resources for a transmission of a dedicated control signal such as a D2D specific control signal by a communication network control element like a controlling eNB or the like, and for transmitting and processing the control signal.

This object is achieved by the measures defined in the attached claims.

According to an example of an embodiment of the proposed solution, there is provided, for example, an apparatus comprising a determining processing portion configured to determine free resources of linked resources of at least one downlink control channel used for transmitting an acknowledgement/non-acknowledgement feedback indication, wherein the linked resources are linked to specified uplink resources for a communication connection and the free resources are not occupied by a signal related to the acknowledgement/non-acknowledgement feedback indication, and a control signal transmitting portion configured to send dedicated control information related to a communication function being different to the acknowledgement/non-acknowledgement feedback indication via the determined free resources of the linked resources.

Furthermore, according to an example of an embodiment of the proposed solution, there is provided, for example, a method comprising determining free resources of linked resources of at least one downlink control channel used for transmitting an acknowledgement/non-acknowledgement feedback indication, wherein the linked resources are linked to specified uplink resources for a communication connection and the free resources are not occupied by a signal related to the acknowledgement/non-acknowledgement feedback indication, and sending dedicated control information related to a communication function being different to the acknowledgement/non-acknowledgement feedback indication via the determined free resources of the linked resources.

In addition, according to a further example of an embodiment of the proposed solution, there is provided, for example, an apparatus comprising a configuration processing portion configured to set resources of linked resources of at least one downlink control channel used for transmitting an acknowledgement/non-acknowledgement feedback indication as selected resources for receiving dedicated control information related to a communication function being different to the acknowledgement/non-acknowledgement feedback indication, wherein the linked resources are linked to specified uplink resources for a communication connection, and a control signal receiving portion configured to receive and process the dedicated control information related to the communication function being different to the acknowledgement/non-acknowledgement feedback indication at the selected resources of the linked resources.

Furthermore, according to an example of an embodiment of the proposed solution, there is provided, for example, a method comprising conducting a configuration processing for setting resources of linked resources of at least one downlink control channel used for transmitting an acknowledgement/non-acknowledgement feedback indication as selected resources for receiving dedicated control information related to a communication function being different to the acknowledgement/non-acknowledgement feedback indication, wherein the linked resources are linked to specified uplink resources for a communication connection, and receiving and processing dedicated control information related to the communication function being different to the acknowledgement/non-acknowledgement feedback indication at the selected resources of the linked resources.

In addition, according to examples of the proposed solution, there is provided, for example, a computer program product for a computer, comprising software code portions for performing the steps of the above defined methods, when said product is run on the computer. The computer program product may comprise a computer-readable medium on which said software code portions are stored. Furthermore, the computer program product may be directly loadable into the internal memory of the computer and/or transmittable via a network by means of at least one of upload, download and push procedures.

By virtue of the proposed solutions, it is possible to provide a mechanism usable for configuring a communication network such that it is possible to provide control signals or control information, such as a D2D specific control signal, to a communication network element, such as a D2D communication device, by using an existing downlink control channel, such as a PHICH. Specifically, by means of examples of embodiments of the invention, it is possible to transmit a control signal, e.g. a one-bit D2D specific signal, from a communication network control element to a communication network element by using resources of a DL control channel which are not used by 1D the generic function of the control channel, and to configure the sender and the recipient of the control signal such that the control signal is properly transmitted wherein a collision with signals related to the original function of the channel, such as a HARQ signaling, is avoided.

The above and still further objects, features and advantages of the invention will become more apparent upon referring to the description and the accompanying drawings.

### BRIEF DESCRIPTION OF THE DRAWINGS

FIG. 1 shows a signaling diagram illustrating a procedure for transmitting dedicated control signal using a DL control channel according to an example of an embodiment of the invention.

FIG. 2 shows a flow chart illustrating a procedure conducted by a communication network control element according to an example of an embodiment of the invention.

FIG. 3 shows a flow chart illustrating a procedure conducted by a communication network element according to an example of an embodiment of the invention.

FIG. 4 shows a block circuit diagram of a communication network control element including processing portions conducting functions according to examples of embodiments of the invention.

FIG. 5 shows a block circuit diagram of a communication network element including processing portions conducting functions according to examples of embodiments of the invention.

FIG. 6 shows a diagram illustrating a pairing example of PHICH resources according to an example of an embodiment of the invention.

### DESCRIPTION OF PREFERRED EMBODIMENTS

In the following, examples and embodiments of the present invention are described with reference to the drawings. For illustrating the present invention, the examples and embodiments will be described in connection with a cellular communication network based on a 3GPP LTE system. However, it is to be noted that the present invention is not limited to an application using such types of communication system, but is also applicable in other types of communication systems and the like.

A basic system architecture of a communication network where examples of embodiments of the invention are applicable may comprise a commonly known architecture of one or more communication systems comprising a wired or wireless access network subsystem and a core network. Such an architecture may comprise one or more access network control elements, radio access network elements, access service network gateways or base transceiver stations, such as a base station (BS) or eNB, with which a communication network element or device such as a UE or another device having a similar function, such as a modem chipset, a chip, a module etc., which can also be part of a UE or attached as a separate element to a UE, or the like, is capable to communicate via one or more channels for transmitting several types of data. Furthermore, core network elements such as gateway network elements, policy and charging control network elements, mobility management entities and the like may be comprised.

The general functions and interconnections of the described elements, which also depend on the actual network type, are known to those skilled in the art and described in corresponding specifications, so that a detailed description thereof is omitted herein. However, it is to be noted that several additional network elements and signaling links may be employed for a communication connection to or from a communication network element like a UE or a communication network control element like an eNB, besides those described in detail herein below.

Furthermore, the described network elements, such as communication network elements like UEs or communication network control elements like BSs or eNBs, and the like, as well as corresponding functions as described herein may be implemented by software, e.g. by a computer program product for a computer, and/or by hardware. In any case, for executing their respective functions, correspondingly used devices, nodes or network elements may comprise several means and components (not shown) which are required for control, processing and communication/signaling functionality. Such means may comprise, for example, one or more processor units including one or more processing portions for executing instructions, programs and for processing data, memory means for storing instructions, programs and data, for serving as a work area of the processor or processing portion and the like (e.g. ROM, RAM, EEPROM, and the like), input means for inputting data and instructions by software (e.g. floppy diskette, CD-ROM, EEPROM, and the like), user interface means for providing monitor and manipulation possibilities to a user (e.g. a screen, a keyboard and the like), interface means for establishing links and/or connections under the control of the processor unit or portion (e.g. wired and wireless interface means, an antenna, etc.) and the like. It is to be noted that in the present specification processing portions should not be only considered to represent physical portions of one or more processors, but may also be considered as a logical division of the referred processing tasks performed by one or more processors.

As described above, according to examples of embodiments of the invention, control signals or control information, such as a D2D specific control signal, is provided to a communication network element, such as a D2D communication device, by using a DL control channel so that, for example, a one-bit D2D specific signal can be sent from a communication network control element such as a eNB to a communication network element. According to examples of embodiments of the invention, one candidate for such a DL control channel, which is usable in connection with the proposed control mechanism, is the PHICH.

The PHICH is configured to carry DL hybrid-ARQ ACK/NACK information in response to UL-SCH transmissions, i.e. it conveys ACK/NACK information for packets received in UL. There is one PHICH transmitted per received transport block and TTI. That is, when UL spatial multiplexing is used on a component carrier, two PHICHs are used to acknowledge (or non-acknowledge) the transmission (or request retransmission), i.e. one per transport block.

The PHICH configuration is part of the system information transmitted by a communication network control element, such as an eNB, to a UE or device to be controlled, for example by means of broadcasting on PBCH, and is thus semi-static in nature. For example, one bit may indicate whether the duration of the PHICH is one or three OFDM symbols in time-frequency multiplexing transmission scheme, and two bits may indicate the amount of resources in the control region reserved for PHICHs, for example expressed as a fraction of the DL cell bandwidth in terms of resource blocks.

Furthermore, multiple PHICHs may be mapped on the same set of resource elements (REs) which constitute a PHICH group. PHICHs within the same PHICH group are separated or spread through different orthogonal Walsh sequences.

A PHICH resource is identified by an index pair (n_{PHICH}^{group}, n_{PHICH}^{seq}), where n_{PHICH}^{group} is the PHICH group number and n_{PHICH}^{seq} is the orthogonal sequence index within the group. In order to lower the control signaling overhead, the PHICH index pair may be associated implicitly with the index of the lowest UL resource block used for the corresponding PUSCH transmission and the cyclic shift of the corresponding UL demodulation reference signal.

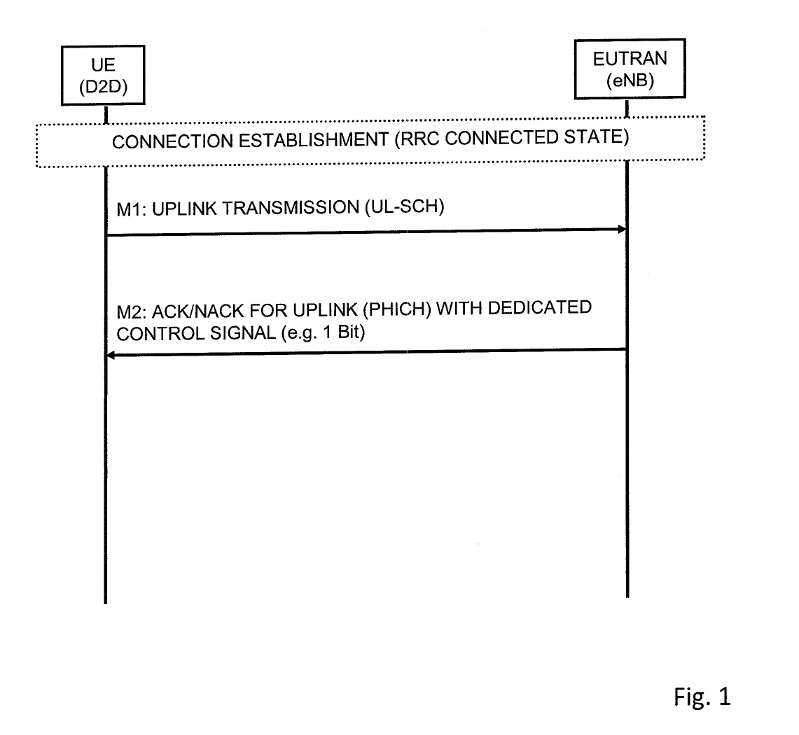

With regard to FIG. 1, a signaling diagram is shown which illustrates a procedure for transmitting a dedicated control signal using a DL control channel such as PHICH according to an example of an embodiment of the invention. Specifically, a UE which is capable of acting as a D2D device, for example, conducts a communication with a communication network control element, such as an eNB. In this communication, first, a connection establishment procedure is conducted after which the UE is in a connected state, such as an RRC_CONNECTED state.

In message M1, an UL transmission from the UE to the eNB is conducted, for example via an UL-SCH. In response to the signaling, in message M2, the eNB sends ACK/NACKs for the UL transmission in M1, for example by means of an HARQ mechanism using PHICH.

According to examples of embodiments of the invention, from the resources of the DL control channel, that is of the PHICH in the example shown in FIG. 1, i.e. PHICH resources which are linked to and engaged by allocated uplink resources for the UE being in the RRC_CONNECTED mode (also referred to hereinafter as linked resources), those resources which not used to convey signals of the original purpose of the channel, i.e. for example HARQ ACK/NACK information in case of PHICH (also referred to hereinafter as free resources or unused resources), in other words resources being not occupied by actual signals to be transmitted for e.g. ACK/NACK information, are set to be used for transmitting certain dedicated control signal, e.g. a dedicated D2D specific control signal. Thus, as indicated in FIG. 1, in connection with the ACK/NACK signaling usually transmitted via PHICH, a dedicated control signal, for example one bit, can be sent to the (D2D) device or UE.

According to examples of embodiments of the invention, in case the dedicated control signal is used as a D2D specific control signal, the signal may be a one-bit request for requesting to add a D2D buffer status into the next possible cellular UL transmission or UL data frame. This request may be further specified, for example, by the sort of information provided by the PHICH for a corresponding UL transmission, i.e. whether an ACK or a NACK for a corresponding uplink transmission is transmitted. For example, when an ACK is transmitted, the D2D buffer status may be included in the next new MAC PDU to the eNB. Otherwise, in case of a NACK for a corresponding uplink transmission, the D2D buffer status information may be added into a next retransmission, in case new resources are indicated for the retransmission (e.g. by PDCCH signaling).

According to another example of embodiments of the invention, in case the dedicated control signal is used as a D2D specific control signal, the signal may be a one-bit request for indicating that a next periodic SR is to be sent according to a D2D buffer status, that is when e.g. pre-configured threshold is achieved which threshold may be given via RRC signaling or the like.

According to further examples of embodiments of the invention, specific rules are provided which are to be followed by the network elements (e.g. D2D device, eNB) so as to avoid collisions between resources used for the original purpose, i.e. ACK/NACK signaling, and free resources used for signaling control information related to the other communication function such as D2D. Information related to these rules may be preset in the respective network elements or be signaled as configuration data between the communication network control element and the communication network element.

For example, according to one example of an embodiment of the invention, specific resources may be reserved for signaling of the dedicated control signal. That is, for example, portions of one orthogonal band sequence of the channel is set for transmitting only information related to the ACK/NACK feedback indication or the like (i.e. the original purpose of the control channel signaling) while portions of the other orthogonal band sequence of the channel are set for transmitting only the dedicated control information related to the different communication function (i.e. D2D). In the case of the PHICH, that means that a in case the device to which the eNB sends HARQ ACK/NACK information is a D2D device, the eNB decides that in case the PHICH resource for ACK/NACK is transmitted using e.g. a certain I branch sequence, i.e. sequence indices 0, 1, 2 or 3, the corresponding Q branch sequence of the same PHICH group, i.e. sequence indices 4, 5, 6 or 7, is reserved for transmitting a possible D2D signal.

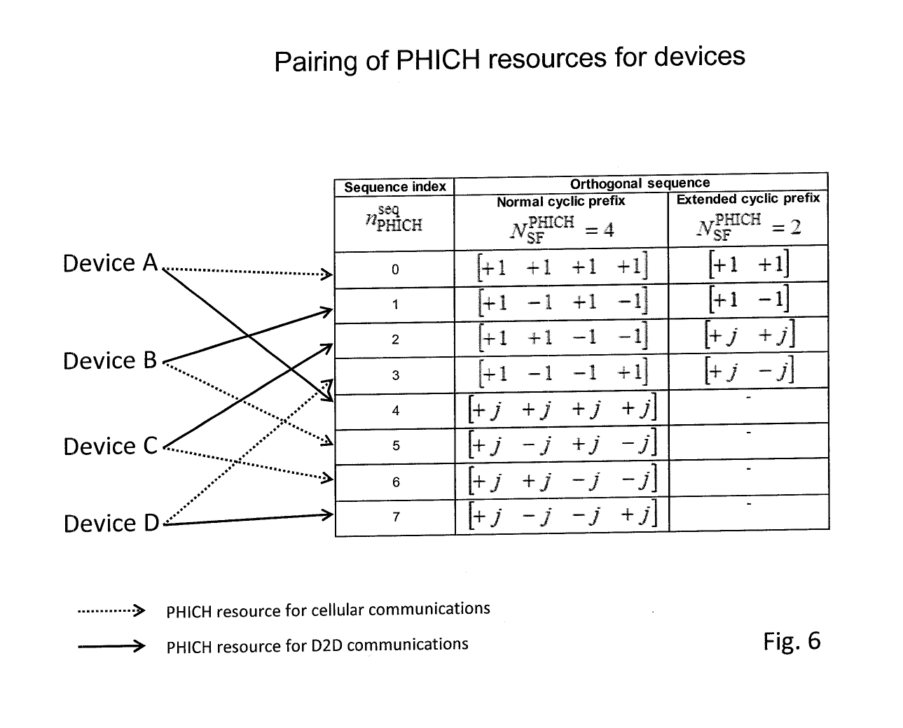

In FIG. 6, a diagram illustrating a possible pairing of PHICH resources according to a corresponding example of an embodiment of the invention is shown. In the diagram according to FIG. 6, for respective devices A, B, C and D, sequence index pairs for sequence indices n_{PHICH}^{seq} 0 to 7 in case of a normal cyclic prefix (with a spreading factor size for PHICH N_{SF}^{PHICH}=4 in comparison to an extended cyclic prefix with N_{SF}^{PHICH}=2 is illustrated. Specifically, in the example shown in FIG. 6, as an exemplary pairing, sequence index pairs of corresponding I and Q branch sequences are formed by pairing indices 0 and 4 for device A, 1 and 5 for device B, 2 and 6 for device C, and 3 and 7 for device D, for example, wherein the indices indicated by the dotted arrows are used for cellular communication resources, and the indices indicated by the solid arrows are used for D2D communication resources, for example.

According to further examples of embodiments of the invention, as a further means for avoiding collisions, the eNB may consider to not allocate the specific Q branch sequence of that PHICH group which is reserved for D2D specific signaling to any other device.

It is to be noted that the above rule may be applied also other way around, i.e. a corresponding I branch sequence being related to the Q branch sequence used for HARQ ACK/NACK signaling towards a D2D device may be reserved for D2D specific signaling.

According to one possible example of an embodiment of the invention, a relation between I and Q branch sequences may be derived by taking an XOR operation of PHICH sequence index, let it be I or Q branch sequence, by itself. As an example, with a 3-bit sequence index, the corresponding pair sequence mapping may be 0 and 7, 1 and 6, 2 and 5, and 3 and 4.

As a further rule, according to examples of embodiments of the invention, a predetermined mapping of a portion being set in the orthogonal band sequence used for transmitting the ACK/NACK feedback indication to a portion being set in the other orthogonal band sequence used for transmitting the dedicated D2D control information related may be conducted. For example, in case the D2D device is assigned to a Q branch sequence for D2D specific signaling, i.e. either sequence index 4, 5, 6 or 7, that may be interpreted as an indication that there is no reservation for D2D specific signaling on the paired I branch sequence. Again, the rule may be applied also other way around.

According to a further possible example of an embodiment of the invention, measures to prevent burden in either of the I or Q branches when aforementioned defined rule is applied are taken. Specifically, the mapping between I and Q branches for D2D devices may be PHICH group specific, wherein corresponding information for configuring the transmission system may be provided by the eNB via a dedicated RRC signaling or broadcasted via system information. For example, for a specific D2D device, PHICH group 0 may be defined such that the I branch is set for HARQ ACK/NACK information transmission while the Q branch is set for D2D specific signaling, PHICH group 1 may be defined such that the I branch is set for D2D specific signaling while the Q branch is set for HARQ ACK/NACK transmission, and the rest of the PHICH groups is set such that both branches (I and Q) are set for HARQ ACK/NACK transmissions.

Furthermore, according to examples of embodiments of the invention, multiple differently configured groups may be configured for a specific D2D device.

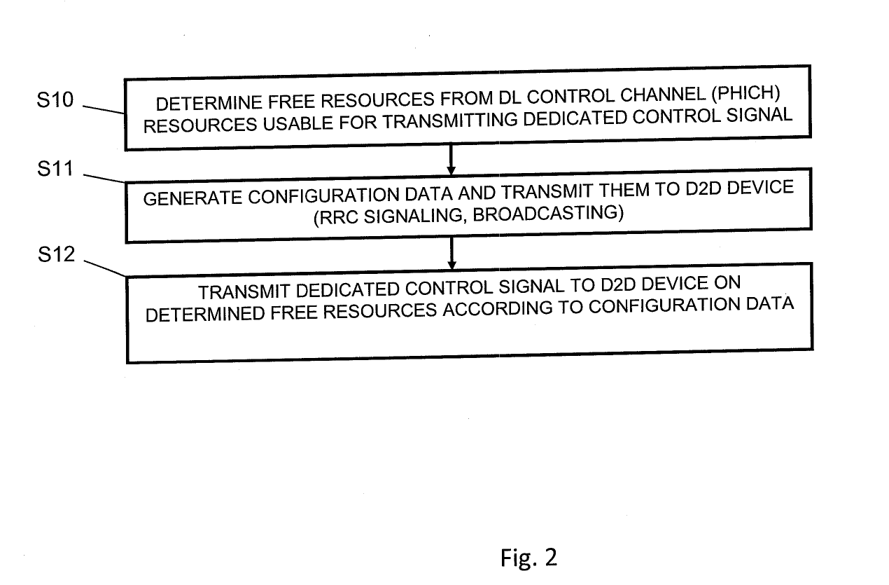

FIG. 2 shows a flow chart illustrating a procedure conducted by a communication network control element, such as an eNB as shown in FIG. 1, according to an example of an embodiment of the invention.

In step S10, it is determined whether and which resources can be assumed as being free resources, i.e. which resources of the linked resources of at least one downlink control channel (e.g. a PHICH or group of PHICH) used for transmitting ACK/NACK feedback indication to a (D2D) device are not occupied for signaling ACK/NACK information, wherein these free resources are set as being used for possible D2D specific signaling (e.g. of the one-bit control signal).

In step S11, configuration information indicating selected resources of the determined free resources used for sending the D2D specific control signal are generated and transmitted to the D2D device in order to enable correct receipt of the control signal.

In step S12, the D2D specific control information is sent to the D2D device by using the selected free resources.

It is to be noted that the above described measures for setting portions of the orthogonal I and Q band sequences and the mapping thereof may be executed, for example, in step S10, wherein corresponding information are considered also in step S11.

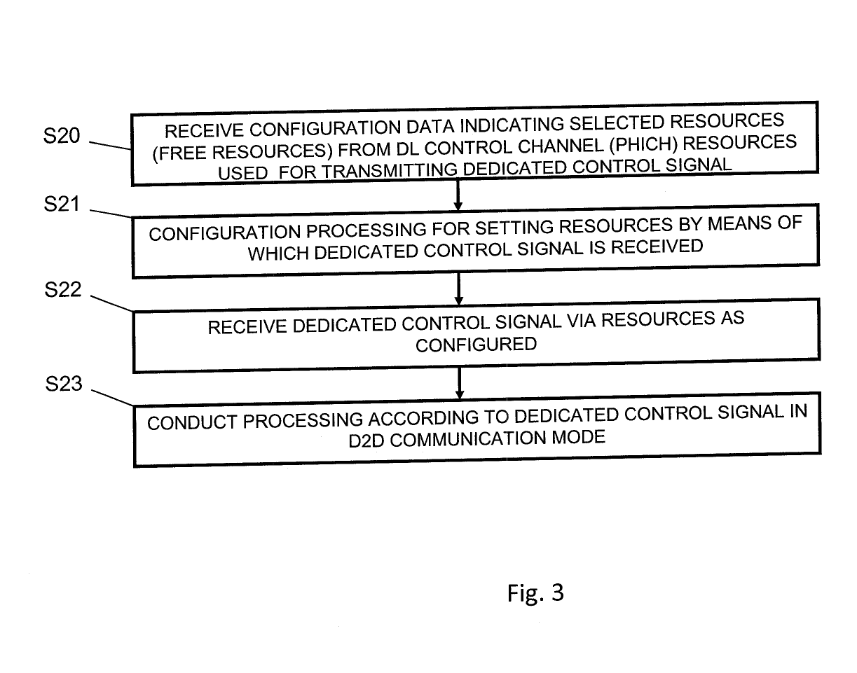

FIG. 3 shows a flow chart illustrating a procedure conducted by a communication network element such as a D2D capable UE as shown in FIG. 1, according to an example of an embodiment of the invention.

In step S20, configuration data are received (e.g. those sent in step 511 in FIG. 2, and in step S21 a configuration processing is conducted for setting resources of the linked resources of at least one DL control channel used for transmitting an ACK/NACK feedback indication (e.g. PHICH or group of PHICH) as selected resources for receiving dedicated control information (D2D specific control signal) related to e.g. D2D communication, in other words for specifying those resources of the PHICH or the like which are to be monitored for D2D specific control signaling.

In step S22, the dedicated control information (D2D) is received at the selected resources of the PHICH or the like being set or specified in step S21.

In step S23, a corresponding processing is conducted in accordance with the received D2D specific control information, for example the above mentioned D2D buffer status transmission or the SR request.

It is to be noted that the above described measures for setting portions of the orthogonal I and Q band sequences and the mapping thereof may be executed, for example, in step S21, wherein corresponding information may be received in step S20.

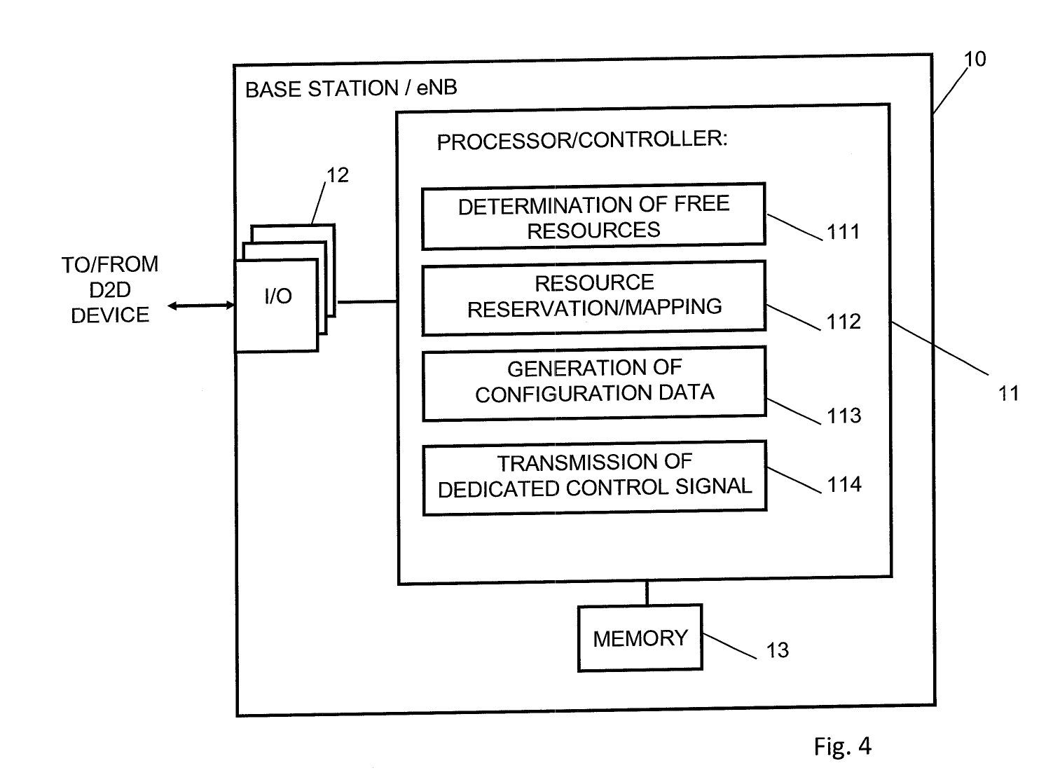

In FIG. 4, a block circuit diagram illustrating a configuration of a communication network control element, such as an eNB, is shown, which is configured to implement the processing for configuring resources and transmitting control signal related to a D2D communication function as described in connection with the examples of embodiments of the invention. It is to be noted that the communication network control element or eNB 10 shown in FIG. 4 may comprise several further elements or functions besides those described herein below, which are omitted herein for the sake of simplicity as they are not essential for understanding the invention. Furthermore, even though reference is made to an eNB, the communication network element may be also another device having a similar function, such as a modem chipset, a chip, a module etc., which can also be part of a BS or attached as a separate element to a BS, or the like.

The communication network control element or eNB 10 may comprise a processing function or processor 11, such as a CPU or the like, which executes instructions given by programs or the like related to the control signal transmission control. The processor 11 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. Reference sign 12 denote transceiver or input/output (I/O) unit connected to the processor 11. The I/O unit 12 may be used for communicating with a communication network element like a UE. The I/O unit 12 may be a combined unit comprising communication equipment towards several network elements, or may comprise a distributed structure with a plurality of different interfaces for different network elements. Reference sign 13 denotes a memory usable, for example, for storing data and programs to be executed by the processor 11 and/or as a working storage of the processor 11.

The processor 11 is configured to execute processing related to the above described mechanism for configuring resources and transmitting a control signal related to a D2D communication function. In particular, the processor 11 comprises a sub-portion 111 as a processing portion which is usable for determining the free resources of the linked resources of the control channel. The portion 111 may be configured to perform processing according to step S20 according to FIG. 2, for example. Furthermore, the processor 11 comprises a sub-portion 112 as a resource reservation and resource mapping processing portion, i.e. to select resources for transmitting the D2D specific control signal and for mapping the I/Q branch sequences, for example. Moreover, the processor 11 comprises a sub-portion 113 as a processing portion which is usable for generating the configuration data for informing the D2D device about the selected resources, for example. The portion 113 may be configured, for example, to perform a processing according to step S11 according to FIG. 2, for example. In addition, the processor 11 comprises a sub-portion 114 as a processing portion which is usable for transmitting the dedicated control signal to the recipient, e.g. the D2D device. The portion 114 may be configured, for example, to perform a processing according to step S12 according to FIG. 2, for example.

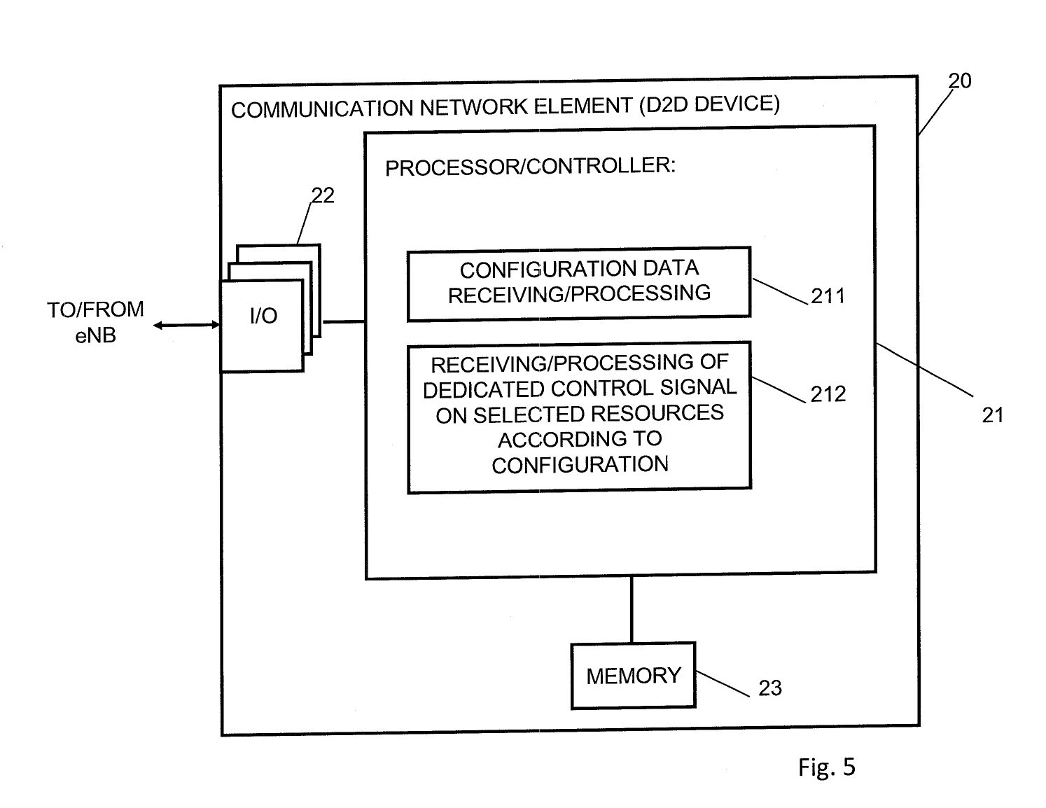

In FIG. 5, a block circuit diagram illustrating a configuration of a communication network element, such as of UE, is shown, which is configured to implement the processing for configuring resources and transmitting control signal related to a D2D communication function as described in connection with the examples of embodiments of the invention, for example. It is to be noted that the communication network device or UE 20 shown in FIG. 5 may comprise several further elements or functions besides those described herein below, which are omitted herein for the sake of simplicity as they are not essential for understanding the invention. Furthermore, even though reference is made to a UE, the communication network element may be also another device having a similar function, such as a modem chipset, a chip, a module etc., which can also be part of a UE or attached as a separate element to a UE, or the like.

The communication network element or UE 20 may comprise a processing function or processor 21, such as a CPU or the like, which executes instructions given by programs or the like related to the control signal transmission control. The processor 21 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. Reference sign 22 denotes transceiver or input/output (I/O) units connected to the processor 21. The I/O units 22 may be used for communicating with elements of the access network, such as a communication network control element like an eNB. The I/O units 22 may be a combined unit comprising communication equipment towards several of the network element in question, or may comprise a distributed structure with a plurality of different interfaces for each network element in question. Reference sign 23 denotes a memory usable, for example, for storing data and programs to be executed by the processor 21 and/or as a working storage of the processor 21.

The processor 21 is configured to execute processing related to the above described mechanism for configuring resources and transmitting control signal related to a D2D communication function, for example. In particular, the processor 21 comprises a sub-portion 211 as a processing portion which is usable for receiving and/or processing configuration data so as to set selected resources of a control channel like PHICH for receiving D2D specific control signaling. The portion 211 may be configured to perform processing according to steps S20 and S21 according to FIG. 3, for example. Furthermore, the processor 21 comprises a sub-portion 212 as a processing portion which is usable as a portion for receiving and/or processing the dedicated control signal via the selected resources. The portion 212 may be configured to perform processing according to step S22 and S23 according to FIG. 3, for example.

As described above, examples of embodiments of the invention are described to be implemented in UEs and eNBs. However, the invention is not limited to this. For example, examples of embodiments of the invention may be implemented in a wireless modem or the like.

According to further examples of embodiments of the invention, there is provided an apparatus comprising determining processing means for determining free resources of linked resources of at least one downlink control channel used for transmitting an acknowledgement/non-acknowledgement feedback indication, wherein the linked resources are linked to specified uplink resources for a communication connection and the free resources are not occupied by a signal related to the acknowledgement/non-acknowledgement feedback indication, and control signal transmitting means for sending dedicated control information related to a communication function being different to the acknowledgement/non-acknowledgement feedback indication via the determined free resources of the linked resources.

Moreover, according to a further example of an embodiment of the invention, there is provided an apparatus comprising configuration processing means for setting resources of linked resources of at least one downlink control channel used for transmitting an acknowledgement/non-acknowledgement feedback indication as selected resources for receiving dedicated control information related to a communication function being different to the acknowledgement/non-acknowledgement feedback indication, wherein the linked resources are linked to specified uplink resources for a communication connection, and control signal receiving means for receiving and processing the dedicated control information related to the communication function being different to the acknowledgement/non-acknowledgement feedback indication at the selected resources of the linked resources.

According to further examples of embodiments of the invention, there is provided, according to an aspect A, a method comprising determining free resources of linked resources of at least one downlink control channel used for transmitting an acknowledgement/non-acknowledgement feedback indication, wherein the linked resources are linked to specified uplink resources for a communication connection and the free resources are not occupied by a signal related to the acknowledgement/non-acknowledgement feedback indication, and sending dedicated control information related to a communication function being different to the acknowledgement/non-acknowledgement feedback indication via the determined free resources of the linked resources.

According to an aspect A1, the method according to aspect A further comprises transmitting configuration information indicating selected resources of the determined free resources used for sending the dedicated control information.

According to an aspect A2, in the method according to aspect A or A1, the communication function being different to the acknowledgement/non-acknowledgement feedback indication is a device-to-device communication function, and the dedicated control information is a device-to-device specific control signal.

According to an aspect A3, in the method according to aspect A2, the dedicated control information indicates at least one of a request to add a buffer status information in a next possible uplink data frame signaling, wherein a type of the signaling to which the buffer status information is to be added is selected in dependence of whether an acknowledgement feedback indication or a non-acknowledgement feedback indication for an uplink transmission is sent via the linked resources, and a request of sending a next scheduling request in dependence of a buffer status.

According to an aspect A4, in the method according to any of aspects A to A3, the at least one downlink control channel comprises a physical hybrid automatic repeat request indicator control channel or a group of plural physical hybrid automatic repeat request indicator control channels.

According to an aspect A5, the method according to aspect A4 further comprises setting portions of one orthogonal band sequence for transmitting only information related to the acknowledgement/non-acknowledgement feedback indication, and setting portions of the other orthogonal band sequence for transmitting only the dedicated control information related to the different communication function.

According to an aspect A6, the method according to aspect A5 further comprises conducting a predetermined mapping of a portion being set in the orthogonal band sequence used for transmitting the acknowledgement/non-acknowledgement feedback indication to a portion being set in the other orthogonal band sequence used for transmitting the dedicated control information related to the different communication function.

According to an aspect A7, the method according to any of aspects A to A6 is implemented in a communication network control element controlling a communication with at least one communication network element by the downlink control channel.

According to still further examples of embodiments of the invention, there is provided, according to an aspect B, a method comprising conducting a configuration processing for setting resources of linked resources of at least one downlink control channel used for transmitting an acknowledgement/non-acknowledgement feedback indication as selected resources for receiving dedicated control information related to a communication function being different to the acknowledgement/non-acknowledgement feedback indication, wherein the linked resources are linked to specified uplink resources for a communication connection, and receiving and processing dedicated control information related to the communication function being different to the acknowledgement/non-acknowledgement feedback indication at the selected resources of the linked resources.

According to an aspect B1, the method according to aspect B further comprises receiving and processing configuration information indicating the selected resources of the linked resources used for transmission of the dedicated control information in advance. According to an aspect B2, in the method according to aspect B or B1, the communication function being different to the acknowledgement/non-acknowledgement feedback indication is a device-to-device communication function, and the dedicated control information is a device-to-device specific control signal.

According to an aspect B3, in the method according to aspect B2, the dedicated control information indicates at least one of a request to add a buffer status information in a next possible uplink data frame signaling, wherein a type of the signaling to which the buffer status information is to be added is selected in dependence of whether an acknowledgement feedback indication or a non-acknowledgement feedback indication for an uplink transmission is sent via the linked resources, and a request of sending a next scheduling request in dependence of a buffer status, wherein the processing of the dedicated control information further comprises starting a process corresponding to the received dedicated control information.

According to an aspect B4, in the method according to any of aspects B to B3, the at least one downlink control channel comprises a physical hybrid automatic repeat request indicator control channel or a group of plural physical hybrid automatic repeat request indicator control channels.

According to an aspect B5, in the method according to aspect B4, the configuration processing further comprises setting portions of one orthogonal band sequence for receiving only information related to the acknowledgement/non-acknowledgement feedback indication and setting portions of the other orthogonal band sequence for receiving only the dedicated control information related to the different communication function.

According to an aspect B6, in the method according to aspect B5, the configuration processing further comprises conducting a predetermined mapping of a portion being set in the orthogonal band sequence used for transmitting the acknowledgement/non-acknowledgement feedback indication to a portion being set in the other orthogonal band sequence used for transmitting the dedicated control information related to the different communication function.

According to an aspect B7, the method according to any of aspects B to B6 is implemented in a communication network element being controlled by a communication network control element to which the downlink control channel is established.

In addition, according to examples of embodiments of the present invention, according to an aspect C, a computer program product for a computer, comprising software code portions for performing the steps of the above defined methods according to any of aspects A to A7 or B to B7, when said product is run on the computer. The computer program product according to aspect C may further comprise a computer-readable medium on which said software code portions are stored. Furthermore, the computer program product may be directly loadable into the internal memory of the computer and/or transmittable via a network by means of at least one of upload, download and push procedures.

For the purpose of the present invention as described herein above, it should be noted that
an access technology via which signaling is transferred to and from a network element may be any technology by means of which a network element or sensor node can access another network element or node (e.g. via a base station or generally an access node). Any present or future technology, such as WLAN (Wireless Local Access Network), WiMAX (Worldwide Interoperability for Microwave Access), LTE, LTE-A, Bluetooth, Infrared, and the like may be used; although the above technologies are mostly wireless access technologies, e.g. in different radio spectra, access technology in the sense of the present invention implies also wired technologies, e.g. IP based access technologies like cable networks or fixed lines but also circuit switched access technologies; access technologies may be distinguishable in at least two categories or access domains such as packet switched and circuit switched, but the existence of more than two access domains does not impede the invention being applied thereto,
usable communication networks and transmission nodes may be or comprise any device, apparatus, unit or means by which a station, entity or other user equipment may connect to and/or utilize services offered by the access network; such services include, among others, data and/or (audio-) visual communication, data download etc.;
a user equipment or communication network element may be any device, apparatus, unit or means which is usable as a user communication device and by which a system user or subscriber may experience services from an access network, such as a mobile phone, a wireless mobile terminal, a personal digital assistant PDA, a smart phone, a personal computer (PC), a laptop computer, a desktop computer or a device having a corresponding functionality, such as a modem chipset, a chip, a module etc., which can also be part of a UE or attached as a separate element to a UE, or the like, wherein corresponding devices or terminals may be, for example, a TETRA (Terrestrial Trunked Radio), a LTE, an UMTS, a GSM/EDGE etc. smart mobile terminal or the like;
method steps likely to be implemented as software code portions and being run using a processor at a network element or terminal (as examples of devices, apparatuses and/or modules thereof, or as examples of entities including apparatuses and/or modules for it), are software code independent and can be specified using any known or future developed programming language as long as the functionality defined by the method steps is preserved;
generally, any method step is suitable to be implemented as software or by hardware without changing the idea of the invention in terms of the functionality implemented;
method steps and/or devices, apparatuses, units or means likely to be implemented as hardware components at a terminal or network element, or any module(s) thereof, are hardware independent and can be implemented using any known or future developed hardware technology or any hybrids of these, such as a microprocessor or CPU (Central Processing Unit), MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components; in addition, any method steps and/or devices, units or means likely to be implemented as software components may for example be based on any security architecture capable e.g. of authentication, authorization, keying and/or traffic protection;
devices, apparatuses, units or means can be implemented as individual devices, apparatuses, units or means, but this does not exclude that they are implemented in a distributed fashion throughout the system, as long as the functionality of the device, apparatus, unit or means is preserved; for example, for executing operations and functions according to examples of embodiments of the invention, one or more processors may be used or shared in the processing, or one or more processing sections or processing portions may be used and shared in the processing, wherein one physical processor or more than one physical processor may be used for implementing one or more processing portions dedicated to specific processing as described,
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

As described above, there is provided a mechanism for controlling a transmission of a dedicated control signal or control information to a communication network element. Free resources of a PHICH which are linked to an UL transmission but not occupied by ACK/NACK information are determined and selected for transmitting a D2D specific control signal to a D2D device.

Although the present invention has been described herein before with reference to particular embodiments thereof, the present invention is not limited thereto and various modifications can be made thereto.

1. An apparatus comprising
a determining processing portion configured to determine free resources of linked resources of at least one downlink control channel used for transmitting an acknowledgement/non-acknowledgement feedback indication, wherein the linked resources are linked to specified uplink resources for a communication connection and the free resources are not occupied by a signal related to the acknowledgement/non-acknowledgement feedback indication, and
a control signal transmitting portion configured to send dedicated control information related to a communication function being different to the acknowledgement/non-acknowledgement feedback indication via the determined free resources of the linked resources.

2. The apparatus according to claim 1, further comprising
a configuration informing portion configured to send an information indicating selected resources of the determined free resources used for sending the dedicated control information.

3. The apparatus according to claim 1, wherein the communication function being different to the acknowledgement/non-acknowledgement feedback indication is a device-to-device communication function, and the dedicated control information is a device-to-device specific control signal.

4. The apparatus according to claim 3, wherein the dedicated control information indicates at least one of
a request to add a buffer status information in a next possible uplink data frame signaling, wherein a type of the signaling to which the buffer status information is to be added is selected in dependence of whether an acknowledgement feedback indication or a non-acknowledgement feedback indication for an uplink transmission is sent via the linked resources, and
a request of sending a next scheduling request in dependence of a buffer status.

5. The apparatus according to claim 1, wherein the at least one downlink control channel comprises a physical hybrid automatic repeat request indicator control channel or a group of plural physical hybrid automatic repeat request indicator control channels.

6. The apparatus according to claim 5, further comprising
a resource reservation processing portion configured to set portions of one orthogonal band sequence for transmitting only information related to the acknowledgement/non-acknowledgement feedback indication and to set portions of the other orthogonal band sequence for transmitting only the dedicated control information related to the different communication function.

7. The apparatus according to claim 6, further comprising
a mapping processing portion configured to conduct a predetermined mapping of a portion being set in the orthogonal band sequence used for transmitting the acknowledgement/non-acknowledgement feedback indication to a portion being set in the other orthogonal band sequence used for transmitting the dedicated control information related to the different communication function.

8. The apparatus according to claim 1, wherein the apparatus is comprised in a communication network control element controlling a communication with at least one communication network element by the downlink control channel.

9. A method comprising
determining free resources of linked resources of at least one downlink control channel used for transmitting an acknowledgement/non-acknowledgement feedback indication, wherein the linked resources are linked to specified uplink resources for a communication connection and the free resources are not occupied by a signal related to the acknowledgement/non-acknowledgement feedback indication, and
sending dedicated control information related to a communication function being different to the acknowledgement/non-acknowledgement feedback indication via the determined free resources of the linked resources.

10. An apparatus comprising
a configuration processing portion configured to set resources of linked resources of at least one downlink control channel used for transmitting an acknowledgement/non-acknowledgement feedback indication as selected resources for receiving dedicated control information related to a communication function being different to the acknowledgement/non-acknowledgement feedback indication, wherein the linked resources are linked to specified uplink resources for a communication connection, and
a control signal receiving portion configured to receive and process the dedicated control information related to the communication function being different to the acknowledgement/non-acknowledgement feedback indication at the selected resources of the linked resources.

11. The apparatus according to claim 10, wherein
the configuration processing portion is further configured to receive and process configuration information indicating the selected resources of the linked resources used for transmission of the dedicated control information in advance.

12. The apparatus according to claim 10, wherein the communication function being different to the acknowledgement/non-acknowledgement feedback indication is a device-to-device communication function, and the dedicated control information is a device-to-device specific control signal.

13. The apparatus according to claim 12, wherein the dedicated control information indicates at least one of
a request to add a buffer status information in a next possible uplink data frame signaling, wherein a type of the signaling to which the buffer status information is to be added is selected in dependence of whether an acknowledgement feedback indication or a non-acknowledgement feedback indication for an uplink transmission is sent via the linked resources, and
a request of sending a next scheduling request in dependence of a buffer status,
wherein the control signal receiving portion is further configured to start a process corresponding to the received dedicated control information.

14. The apparatus according to claim 10, wherein the at least one downlink control channel comprises a physical hybrid automatic repeat request indicator control channel or a group of plural physical hybrid automatic repeat request indicator control channels.

15. The apparatus according to claim 14, wherein the configuration processing portion is further configured to
to set portions of one orthogonal band sequence for receiving only information related to the acknowledgement/non-acknowledgement feedback indication and to set portions of the other orthogonal band sequence for receiving only the dedicated control information related to the different communication function.

16. The apparatus according to claim 15, wherein the configuration processing portion is further configured to
conduct a predetermined mapping of a portion being set in the orthogonal band sequence used for transmitting the acknowledgement/non-acknowledgement feedback indication to a portion being set in the other orthogonal band sequence used for transmitting the dedicated control information related to the different communication function.

17. The apparatus according to claim 10, wherein the apparatus is comprised in a communication network element being controlled by a communication network control element to which the downlink control channel is established.
